(19) United States
(12) Patent Application Publication
(10) Pub. No.: US 2005/0154766 A1
(43) Pub. Date: Jul. 14, 2005

(54) Multimedia processing system capable of auto-detecting multimedia signals to facilitate selecting and method of the same

(76) Inventors: Wei-Hung Huang, Hsinchu City (TW); Po-Wen Ku, Hsinchu City (TW)

Correspondence Address: Hoffman, Warnick & D'Alessandro LLC, Three E-Comm Square, Albany, NY, 12207, US

(21) Appl. No.: 11/021,447

(22) Filed: Dec. 23, 2004

(30) Foreign Application Priority Data
Dec. 26, 2003 (TW) 092137182

(51) Int. Cl. G06F 7/00

(52) U.S. Cl. 707/104.1

(57) ABSTRACT

A multimedia processing system includes a selector, an output playback apparatus, a controller, and an A/V signal detector. The selector has a plurality of input ports for receiving multimedia signals and for selecting and outputting one of the multimedia signals according to a selection control signal. The output playback apparatus is used for playing the multimedia signal outputted by the selector in the output playback apparatus. The controller is used for generating the corresponding selection control signals to the selector. The A/V signal detector is used for detecting whether the input ports of the selector have received a newly inputted multimedia signal. When a newly inputted multimedia signal is detected, the A/V signal detector outputs a specific selection signal to the controller, so the controller subsequently generates the corresponding selection control signal to the selector for selecting and outputting the newly inputted multimedia signal to the output playback apparatus.

### BACKGROUND OF THE INVENTION

1. Field of the Invention

The present invention relates to a multimedia processing system and the method thereof, especially to a multimedia processing system capable of auto-detecting multimedia signals so as to facilitate selecting and method of the same.

2. Description of the Prior Art

The multimedia processing system of the prior art, e.g. TV set or computer display screen, is used for processing multimedia signals. The multimedia processing system could generally process and/or reproduce one of a plurality of multimedia signals received from different signal sources. The signal source could be in digital or analog form; could be connected to a digital/analog cable TV receiver, a satellite TV receiver, a digital versatile disc (DVD) player, a video home system (VHS) player, a digital still camera (DSC), an audio playback system (for example, CD player or audio cassette player), etc.

The multimedia processing system of the prior art, e.g. TV set, has a plurality of input ports for receiving multimedia signals from various signal sources. Since the multimedia processing system could only process and/or reproduce one multimedia signal at a time, the multimedia processing system is generally equipped with an infrared remote control for the user to select which multimedia signal to be processed and reproduced.

However, the multimedia processing system of the prior art is inconvenient for the user to select one from the various signal sources. For example, if the multimedia processing system is currently displaying a multimedia signal which is from the cable TV receiver and the user wants to switch to another multimedia signal which is from the DVD player, the user will need to follow several steps. In a common case, the user needs to use the infrared remote control of the DVD player to turn on and operate the DVD player, and use another infrared remote control of the multimedia processing system so the multimedia processing system could switch to process and/or reproduce the multimedia signal from the DVD player. These steps cause inconvenience to the user.

Therefore, a user-friendlier multimedia processing system is desired.

Some related arts are listed in the following as a reference: U.S. Pat. No. 5,109,284, “Apparatus for controlling the operation of a television according to the control signal of a video cassette recorder and a method therefore,” U.S. Pat. No. 5,550,644, “Video cassette recorder capable of automatically setting a television receiver,” U.S. Pat. No. 5,291,343, “Audio/video system for television receiver, video cassette recorder, and so forth,” and U.S. Pat. No. 5,047,867, “Interface for a TV-VCR system.”

### SUMMARY OF THE INVENTION

The present invention provides a user-friendlier multimedia processing system capable of auto-detecting multimedia signals, so the user could easily select a multimedia signal to be processed and/or reproduced. The multimedia signals referred in one embodiment include audio and/or video signals. The method for achieving such purpose is also disclosed.

According to one embodiment, the multimedia processing system includes a selector, an output playback apparatus, a controller, and an audio and/or video (A/V) signal detector. The selector couples to a plurality of input ports for receiving a plurality of multimedia signals from different signal sources and outputting one multimedia signal according to a selection control signal. Each multimedia signal could include both audio and video signals, video signals alone, or audio signals alone. The output playback apparatus is used for processing the A/V signals outputted by the selector, then, reproducing the processed A/V signals in the output playback apparatus. The controller is used for generating the corresponding selection control signals to the selector according to a specific selection input signal. The A/V signal detector is used for detecting whether the input ports coupled to the selector have received a newly inputted multimedia signal. When a newly inputted multimedia signal is detected, the A/V signal detector outputs a specific selection input signal to the controller, so the controller subsequently generates the corresponding selection control signal to control the selector to output the newly inputted multimedia signal. Hence, the output playback apparatus can automatically reproduced the newly selected signal.

Another embodiment of the present invention is an auto-detection and selection method for multimedia signals in a multimedia processing system. When a newly inputted multimedia signal is detected, the auto-detection and selection method outputs a specific selection input signal to the controller, so the controller subsequently generates the corresponding selection control signal to control the selector to output the newly inputted multimedia signal. Hence, the output playback apparatus can automatically reproduce the newly selected signal.

According to the auto-detection and selection method for A/V signals in the A/V playback system provided by the embodiment, the multimedia processing system could auto-detect the inputted A/V signals and could further be used to select the newly inputted multimedia signals. Hence, the user can easily select the inputted multimedia signal after turning on the signal source of the apparatus connected to the multimedia processing system.

These and other objectives of the present invention will no doubt become obvious to those of ordinary skill in the art after reading the following detailed description of the preferred embodiment that is illustrated in the figures and drawings.

### BRIEF DESCRIPTION OF THE APPENDED DRAWINGS

FIG. 1 is a schematic diagram of the multimedia processing system capable of auto-detecting and selecting a multimedia signal according to an embodiment of the present invention.

### DETAILED DESCRIPTION OF THE INVENTION

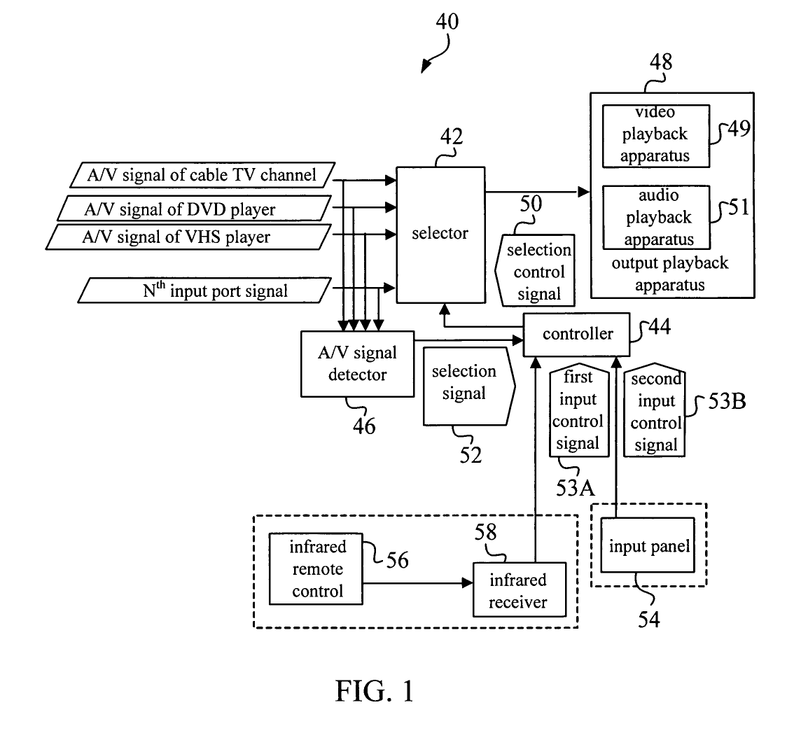

FIG. 1 is a schematic diagram of the multimedia processing system 40 capable of auto-detecting and/or selecting an A/V signal according to an embodiment of the present invention. The multimedia processing system 40 includes a selector 42, a controller 44, an A/V signal detector 46, and an output playback apparatus 48. The multimedia processing system 40 may have various input ports, e.g. a cable port, a plurality sets of A/V terminals, an S-Video input terminal, a chrominance terminal, and so on. In this embodiment, the selector 42 of the A/V playback system 40 has a plurality of sets of input ports for receiving a plurality of multimedia signals from different signal sources, and each set of input port is for receiving a multimedia signal from a signal source. Each multimedia signal could include both audio and video signals, video signals alone, or audio signals alone. A set of input ports could include one or several input ports. The different signal sources include a TV antenna, a cable TV, and other signal sources, e.g. DVD player, VHS player, digital still camera (DSC), a CD player, an audio cassette player, and so on. The selector 42 is used for receiving multimedia signals from the input ports and outputting one of the multimedia signals according to a selection control signal 50 from the controller 44. The output playback apparatus 48 including a video playback apparatus 49 and an audio playback apparatus 51 is used for reproducing the audio and video signals outputted by the selector 42. For example, if the multimedia signal outputted by the selector 42 includes both video signals and audio signals, the output playback apparatus 48 will activate both the video playback apparatus 49 and the audio playback apparatus 51 for reproducing the video and audio signals; if the multimedia signal outputted by the selector 42 includes only video signal from the DSC, the output playback apparatus 48 will activate only the video playback apparatus 49 for reproducing video signals, and the audio playback apparatus don't need to be activated. As shown in FIG. 1, the A/V signal detector 46 of the multimedia processing system 40 is used for detecting the input ports. For example, the input ports of the selector have received a newly inputted multimedia signal. The A/V signal detector can detect the changed status. In other words, the A/V signal detector 46 is used for monitoring whether a new multimedia signal is inputted to the multimedia processing system 40 and for monitoring whether the status of the multimedia signal is changed. The status could be, for example, a newly inputted multimedia signal is received or a previously exited signal is no longer available. The changed status can be determined by a predetermined threshold to recognize whether a new multimedia signal is present when monitoring, so a noise would not interfere the operation of the auto-detection of this embodiment.

The controller 44 is used for generating the corresponding selection control signals 50 to the selector 42 according to different selection input signals. When a newly inputted multimedia signal is detected, the A/V signal detector 46 outputs a selection signal 52 to the controller 44, and the controller 44 subsequently generates the selection control signal 50 to the selector 42 for selecting and outputting the newly inputted multimedia signal to the output playback apparatus 48 to be reproduced. The system can automatically reproduce the multimedia signal via the above-mentioned steps.

The multimedia signal inputted to the selector 42 could include both audio and video signals, video signals alone, or audio signals alone.

In the embodiment shown in FIG. 1, the output playback apparatus could be a TV set including a video playback apparatus 49 (for example, a CRT or LCD display) and an audio playback apparatus 51 (for example, a pair of speakers). It is noted that the output playback apparatus 48 could also be a video playback apparatus, an audio playback apparatus, or an A/V playback apparatus including a playback display apparatus and an audio playback apparatus, e.g. a TV set or a computer display screen with a built-in audio playback apparatus. The video playback apparatus is used for receiving the video signals outputted from the selector 42, processing and reproducing the video signals. The audio playback apparatus is used for receiving the audio signals outputted from the selector 42, processing and reproducing the audio signals.

For example, when the multimedia processing system 40 is processing and/or reproducing the multimedia signal coming from the cable TV, and if a DVD player connected to the multimedia processing system 40 is turned on at this moment, the A/V signal detector 46 could detect a newly inputted multimedia signal from the DVD player to the multimedia processing system 40 and generate a selection signal 52, so as to switch the multimedia processing system 40 from the original multimedia signal coming from the cable TV to the multimedia signal coming from the DVD player.

Similar to the above example, when the multimedia processing system 40 is processing and/or reproducing the multimedia signal of the DVD player, and if a VHS player connected to the multimedia processing system 40 is turned on and start to transmit the A/V signals at this moment, the A/V signal detector 46 can detect a newly inputted multimedia signal from the VHS player to the multimedia processing system 40 and generate a selection signal 52, in order to switch the multimedia processing system 40 from the original multimedia signal coming from the DVD player to the multimedia signal coming from the VHS player.

The selection signal 52 may be generated automatically by the A/V signal detector 46 according to the result of monitoring of the multimedia processing system 40, or be generated manually by the user using an input panel 54 or an infrared remote control 56.

In an embodiment, the manual selection could be realized as follows. The controller 44 is connected to the input panel 54. The input panel 54 has an input interface for a user to select a first input control signal 53A to the controller 44.

In another embodiment, the manual selection could be realized alternatively as follows. The controller 44 could be connected to an infrared receiver 58. The infrared remote controller 56 includes an input interface thereon for a user to select a second input control signal 53B to the infrared receiver 58 via infrared transmission, in order to transmit the selection signal 52 to the controller 44.

When the multimedia processing system 40 is processing and/or reproducing a first multimedia signal, and the A/V signal detector 46 subsequently detects that the first multimedia signal disappears, the A/V signal detector 46 could activate a pop-up menu on the video playback apparatus 49. The pop-up menu illustrates the multimedia signals, which are currently received by the selector 42 and are available for processing and/or reproducing, so the user could easily determine which multimedia signal to be played back.

For example, when the multimedia processing system 40 is playing back the A/V signal of the cable TV, and if a DVD player connected to the multimedia processing system 40 is switched on and start to transmit the A/V signals at this moment. The multimedia processing system 40 will process and reproduce the multimedia signal of the DVD player automatically after detecting and determining the status of the A/V signals on the corresponding input ports has changed. If a VHS player is switched on and start to transmit the A/V signals, the multimedia processing system 40 will process and reproduce the multimedia signal of the VHS player automatically after detecting and determining the status of the A/V signals on the corresponding input ports has changed. At this moment, if the VHS player is switched off and stop to transmit the A/V signals. The A/V signal detector 46 detects that the multimedia signal of the VHS player disappears, the A/V signal detector 46 activate a pop-up menu on the video playback apparatus 49 to illustrate the current multimedia signals of the cable TV and the DVD player which are received by the selector 42 and are available for processing/reproducing, and the user could easily select one of the two multimedia signals to be processed and reproduced by the output playback apparatus 48.

Similar to the above example, if the VHS player is switched off and stop to transmit the A/V signals. The A/V signal detector 46 detects that the multimedia signal of the VHS player disappears, another embodiment may enable the selector 42 to switch to the A/V signal of the cable TV automatically and output the A/V signal to the output playback apparatus 48 instead of activate the pop-up menu. In other words, when the A/V signal detector 46 detects that the first multimedia signal disappears, the selector 42 could be switched to the second multimedia signal, which is from the cable TV, and output the second multimedia signal to the output playback apparatus 48.

As the above embodiment, when the currently processed and reproduced multimedia signal disappears, there are still other methods for auto-selecting the multimedia signals. Accordingly, other variations should also be covered under the range of the present invention.

According to the multimedia processing system 40 and the auto-detection and selection method for multimedia signals of the present invention, the multimedia processing system 40 could detect and determine the change of the inputted multimedia signal sets on the corresponding input ports. A change of the above-mentioned status could be detecting a newly inputted multimedia signal or detecting a previously existed multimedia signal is no longer available. Then, the multimedia processing system could automatically or manually select the wanted inputted A/V signal. So the user could easily select a multimedia signal set from a plurality of the multimedia signal source sets connecting to the multimedia processing system.

With the example and explanations above, the features and spirits of the present invention are well described. Those of ordinary skill in the art will readily observe that numerous modifications and alterations of the device may be made while retaining the present invention.

1. A multimedia processing system comprising:
a selector comprising a plurality of input ports for receiving a plurality of multimedia signals from different signal sources and for selecting and outputting one of the multimedia signals according to a selection control signal;
an output playback apparatus for processing the multimedia signal outputted by the selector and playing the processed multimedia signal in the output playback apparatus;
a controller for generating the corresponding selection control signals to the selector according to different selection signals; and
an audio and/or video (A/V) signal detector for detecting whether the input ports of the selector has received a newly inputted multimedia signal;
wherein when detecting the newly inputted multimedia signal, the A/V signal detector outputs a specific selection signal to the controller, so that the controller subsequently generates the corresponding selection control signal to the selector for selecting and outputting the newly inputted multimedia signal to the output playback apparatus, so as to be auto-played.

2. The multimedia processing system of claim 1, wherein each of the multimedia signals inputted to the selector is a video signal, an audio signal, or a mixed signal including a video signal and an audio signal.

3. The multimedia processing system of claim 2, wherein the output playback apparatus is a video playback apparatus for processing the video signal or the mixed signal including the video signal and the audio signal outputted by the selector and for playing the processed signal in the video playback apparatus.

4. The multimedia processing system of claim 3, wherein the video playback apparatus is a TV set or a computer display screen.

5. The multimedia processing system of claim 3, wherein the A/V signal detector plays a pop-up menu on the video playback apparatus when detecting that the newly inputted multimedia signal appears, and the pop-up menu plays the multimedia signals currently received by the selector in corresponding options for user selection.

6. The multimedia processing of claim 1, wherein one input port of the selector is connected to a multimedia signal from a cable TV channel.

7. The multimedia processing of claim 6, wherein when detecting that the newly inputted multimedia signal appears, the A/V signal detector switches the selector to the multimedia signal from the cable TV channel and outputs the multimedia signal to the output playback apparatus.

8. The multimedia processing of claim 1, wherein the controller is connected to an input panel comprising a plurality of selection keypads for a user to generate a second input control signal to the controller.

9. The multimedia processing of claim 1, wherein the multimedia processing system comprises an infrared remote controller including a plurality of selection keypads thereon for a user to generate a first input control signal to the controller via infrared transmission.

10. The multimedia processing of claim 1, wherein the output playback apparatus is an audio playback apparatus for playing the output signals from the selector to a speaker.

11. An auto-detection/selection method for audio/video signals in a multimedia processing system, the multimedia processing system comprising:
a selector comprising a plurality of input ports for receiving a plurality of multimedia signals from different signal sources and for selecting and outputting one of the multimedia signals according to a selection control signal;
an output playback apparatus for processing the multimedia signal outputted by the selector and playing the processed multimedia signal in the output playback apparatus; and
a controller for generating the corresponding selection control signals to the selector according to different selection signals;
wherein when detecting the newly inputted multimedia signal, the auto-detection/selection method outputs a specific selection signal to the controller, so that the controller subsequently generates the corresponding selection control signal to the selector for selecting and outputting the newly inputted multimedia signal to the output playback apparatus, so as to be auto-played.

12. The auto-detection/selection method of claim 11, wherein each of the multimedia signals inputted to the selector is a video signal, an audio signal, or a mixed signal including a video signal and an audio signal.

13. The auto-detection/selection method of claim 12, wherein the output playback apparatus is a video playback apparatus for processing the video signal or the mixed signal including the video signal and the audio signal outputted by the selector and for playing the processed signal in the video playback apparatus.

14. The auto-detection/selection method of claim 13, wherein the video playback apparatus is a TV set or a computer display screen.

15. The auto-detection/selection method of claim 13, wherein a pop-up menu is played on the video playback apparatus when detecting that the newly inputted multimedia signal appears, and the pop-up menu plays the multimedia signals currently received by the selector in corresponding options for user selection.

16. The auto-detection/selection method of claim 11, wherein one input port of the selector is connected to a multimedia signal from a cable TV channel.

17. The auto-detection/selection method of claim 16, wherein when detecting that the newly inputted multimedia signal appears, the selector is switched to the multimedia signal from the cable TV channel and the multimedia signal is outputted to the output playback apparatus.

18. The auto-detection/selection method of claim 11, wherein the controller is connected to an input panel comprising a plurality of selection keypads for a user to generate a second input control signal to the controller.

19. The auto-detection/selection method of claim 11, wherein the multimedia processing system comprises an infrared remote controller including a plurality of selection keypads thereon for a user to generate a first input control signal to the controller via infrared transmission.

20. The auto-detection/selection method of claim 11, wherein the output playback apparatus is an audio playback apparatus for playing the output signals from the selector to a speaker.
